(19) United States
(12) Patent Application Publication
(10) Pub. No.: US 2026/0230811 A1
(43) Pub. Date: Aug. 6, 2026

(54) MEDIUM ACCESS CONTROL (MAC) LAYER KEY DERIVATION

(71) Applicant: QUALCOMM Incorporated, San Diego, CA (US)

(72) Inventors: Soo Bum LEE, San Diego, CA (US); Karthika PALADUGU, Hyderabad (IN); Gavin Bernard HORN, La Jolla, CA (US)

(21) Appl. No.: 19/046,425

(22) Filed: Feb. 5, 2025

(51) Int. Cl. H04W 12/041; H04W 12/0431; H04W 12/106

(52) U.S. Cl. CPC H04W 12/041; H04W 12/0431; H04W 12/106

(57) ABSTRACT

An apparatus, method and computer-readable media are disclosed for accessing a wireless network. For example, a process for accessing to a wireless network can include: associating a first wireless node with a first cell group; deriving from an access stratum (AS) root key, a first medium access control (MAC) key, wherein the first MAC key is based on a first cell group number associated with the first cell group; and transmitting the first MAC key to the first wireless node, wherein the first MAC key secures MAC messages between the first wireless node and a wireless device.

### FIELD

The present disclosure generally relates to wireless communications. For example, aspects of the present disclosure relate to deriving cryptographic keys for a MAC layer of a wireless network.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. A sixth-generation (6G) mobile standard may build on 5G to offer further increased data transfer speeds, better coverage, and improved security, among other improvements.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. In one illustrative example, an apparatus for communicating with a wireless network is provided. The apparatus includes a memory and a processor coupled to the memory and wherein the processor is configured to: associate a first wireless node with a first cell group; derive from an access stratum (AS) root key, a first medium access control (MAC) key, wherein the first MAC key is based on a first cell group number associated with the first cell group; and transmit the first MAC key to the first wireless node, wherein the first MAC key secures MAC messages between the first wireless node and a wireless device.

As another example, a method for communicating with a wireless network is provided. The method includes: associating a first wireless node with a first cell group; deriving from an access stratum (AS) root key, a first medium access control (MAC) key, wherein the first MAC key is based on a first cell group number associated with the first cell group; and transmitting the first MAC key to the first wireless node, wherein the first MAC key secures MAC messages between the first wireless node and a wireless device.

In another example, a non-transitory computer-readable medium having stored thereon instructions is provided. The instructions, when executed by a processor, cause the processor to: associate a first wireless node with a first cell group; derive from an access stratum (AS) root key, a first medium access control (MAC) key, wherein the first MAC key is based on a first cell group number associated with the first cell group; and transmit the first MAC key to the first wireless node, wherein the first MAC key secures MAC messages between the first wireless node and a wireless device.

As another example, an apparatus for communicating with a wireless network is provided. The apparatus includes: means for associating a first wireless node with a first cell group; means for deriving from an access stratum (AS) root key, a first medium access control (MAC) key, wherein the first MAC key is based on a first cell group number associated with the first cell group; and means for transmitting the first MAC key to the first wireless node, wherein the first MAC key secures MAC messages between the first wireless node and a wireless device.

In another example, an apparatus for communicating with a wireless network is provided. The apparatus includes a memory and a processor coupled to the memory and wherein the processor is configured to: receive, from a centralized wireless node, information for deriving a first medium access control (MAC) key for a first cell group associated with a first wireless node and an access stratum (AS) root key; derive the first MAC key based on the information for deriving the first MAC key and the AS root key; and decode a first MAC message from the first wireless node based on the derived first MAC key.

As another example, a method for communicating with a wireless network is provided. The method includes: receiving, from a centralized wireless node, information for deriving a first medium access control (MAC) key for a first cell group associated with a first wireless node and an access stratum (AS) root key; deriving the first MAC key based on the information for deriving the first MAC key and the AS root key; and decoding a first MAC message from the first wireless node based on the derived first MAC key.

In another example, a non-transitory computer-readable medium having stored thereon instructions is provided. The instructions, when executed by a processor, cause the processor to: receive, from a centralized wireless node, information for deriving a first medium access control (MAC) key for a first cell group associated with a first wireless node and an access stratum (AS) root key; derive the first MAC key based on the information for deriving the first MAC key and the AS root key; and decode a first MAC message from the first wireless node based on the derived first MAC key.

As another example, an apparatus for communicating with a wireless network is provided. The apparatus includes: means for receiving, from a centralized wireless node, information for deriving a first medium access control (MAC) key for a first cell group associated with a first wireless node and an access stratum (AS) root key; means for deriving the first MAC key based on the information for deriving the first MAC key and the AS root key; and means for decoding a first MAC message from the first wireless node based on the derived first MAC key.

In another example, an apparatus for communicating with a wireless network is provided. The apparatus includes a memory and a processor coupled to the memory and wherein the processor is configured to: receive, from a centralized wireless node, a first medium access control (MAC) key for a first cell group; receive a first MAC message from a wireless device; and decode a first MAC message from a wireless device based on the first MAC key.

As another example, a method for communicating with a wireless network is provided. The method includes: receiving, by a wireless node and from a centralized wireless node, a first medium access control (MAC) key for a first cell group associated with the wireless node; receiving a first MAC message from a wireless device; and decoding a first MAC message from a wireless device based on the first MAC key.

In another example, a non-transitory computer-readable medium having stored thereon instructions is provided. The instructions, when executed by a processor, cause the processor to: receive, from a centralized wireless node, a first medium access control (MAC) key for a first cell group; receive a first MAC message from a wireless device; and decode a first MAC message from a wireless device based on the first MAC key.

As another example, an apparatus for communicating with a wireless network is provided. The apparatus includes: means for receiving, by a wireless node and from a centralized wireless node, a first medium access control (MAC) key for a first cell group associated with the wireless node; means for receiving a first MAC message from a wireless device; and means for decoding a first MAC message from a wireless device based on the first MAC key.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 is a is a tree diagram illustrating a key hierarchy for a wireless system, such as wireless communications network, in accordance with aspects of the present disclosure;

FIG. 6 is a block diagram illustrating cell groups in a wireless network, in accordance with aspects of the present disclosure;

FIG. 7 is a is a block diagram illustrating handover with cell groups in a wireless network, in accordance with aspects of the present disclosure;

FIG. 8 is a flow diagram illustrating a process for communicating with a wireless system, in accordance with aspects of the present disclosure;

FIG. 9 is a flow diagram illustrating a process for communicating with a wireless system, in accordance with aspects of the present disclosure;

FIG. 10 is a flow diagram illustrating a process for communicating with a wireless system, in accordance with aspects of the present disclosure; and

FIG. 11 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3^{rd} Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

Various systems and techniques are provided with respect to wireless technologies (e.g., The 3GPP 5G/New Radio (NR) Standard, 6G, etc.) to provide improvements to wireless communications. A device (e.g., a UE, wireless device, mobile device, etc.) can be configured to access a wireless network (e.g., wireless system) to communicate with other devices. As a part of accessing the wireless network, the device may be configured to authenticate with the wireless network. Based on the authentication, the device may establish one or more security contexts to allow for private communications between the device and services of the wireless network. In some wireless networks, a device connecting to the wireless network may establish a security context with a security function of a core network (e.g., non-access stratum (NAS) security). Based on this security context, additional application layer security may be established on top of this security context.

In some cases, access stratum (AS) security may be used to secure a connection between a device and a wireless node of the wireless system that is connected to the device. The wireless node may be a base station (or a part of a disaggregated base station), such as a gNB, eNB, central unit (CU), a distributed unit (DU), etc., through which access to a wireless network may be provided. The AS security may apply a layer of security to a radio interface that connects the device to the wireless node of the wireless system. In some cases, such as for a disaggregated base station, AS security may be anchored at a CU and AS security may be based on a cryptographic key of the CU, such as an AS root key or CU key.

A MAC layer may be a protocol layer of a wireless protocol stack which manages radio resources for communications between wireless nodes and wireless devices in some wireless networks. A wireless protocol stack may be a set of protocols structured in layers which define how wireless devices can communicate with each other. The MAC layer may be hosted by DUs associated with a CU (e.g., centralized wireless node). The centralized wireless node may be a CU and the CU may be a part of a disaggregated base station which provides support for high layers of a wireless protocol stack. The DU may be another part of the disaggregated base station which provides support for lower layers of the wireless protocol stack, such as the MAC layer. The MAC layer may use MAC messages (e.g., in MAC protocol data units (PDU)) to signal various information between a UE (e.g., wireless device) and DU (e.g., wireless node) to manage radio resources. MAC messages may be messages sent and/or received by the MAC layer. In some cases, the MAC PDUs may not be protected from potential attacks, making them vulnerable to attacks which could degrade and/or disrupt a connection between the UE and DU. In some cases, the AS root key may also be used to provide security for the MAC messages.

Systems, apparatuses, processes (also referred to as methods), and computer-readable media (collectively referred to as “systems and techniques”) are described herein for communicating with wireless network securely. For example, a CU may be configured with a set of DUs. The CU may associate (e.g., configure) a first cell group with a first DU. A cell group may be a grouping of wireless nodes, such as one or more DUs, with a common core network configured to perform wireless communications in a certain manner. Traditionally, cell groups were used for dual connectivity where a first cell group of a cell may be configured to communicate using a first protocol, such as 4G/LTE, while a second cell group of the cell may be configured to communicate using a second protocol, such as 5G/NR. The CU may also associate a second cell group with a second DU. The CU may derive a first MAC key using the AS root key of the CU based on a cell group number associated with the first cell group. The cell group number may be an identifier or number associated with a cell group. A MAC key may be a cryptographic key derived from the AS root key and used to secure MAC messages. The CU may also derive a second MAC key using the AS root key and based on the cell group number associated with the second cell group. The MAC key of the first cell group is different from the MAC key of the second cell group. The CU may transmit the first MAC key to the first DU to secure MAC messages between the first DU and a UE connected to the first DU. The CU may also transmit the second MAC key to the second DU to secure MAC messages between the second DU and the UE (e.g., if the UE switches to the second DU).

The MAC key may be derived based on a set of parameters. A parameter may be an input for a function, such as a function for deriving a cryptographic key. This set of parameters may include a string associated with the cell group, a physical cell identifier, an absolute radio frequency channel number for downlink channel binding (ARFCN-DL), or a freshness parameter. The string associated with the cell group may be some text or other value associated with the cell group. The physical cell identifier may be a unique identifier for a cell. The ARFCN-DL may be a code which specifies reference frequencies used for downlink transmissions. In some cases, the MAC key may be refreshed based on the freshness parameter or a current MAC key to generate a refreshed MAC key.

In some cases, the first cell group may be configured as a part of an active cell group and the second cell group may be configured as a part of a candidate cell group. The active cell group may be a cell group which is available for communicating with a UE. The candidate cell group may be a configured cell group which is not available for communicating with the UT, but can be made available. The CU may also provide an indication to the UE of the active cell group and candidate cell group. In some cases, the CU may switch the first cell group such that the first cell group is configured as a candidate cell group, and the second cell group is configured as an active cell group.

In some examples, the CU may also provide the UE with key derivation parameters for a third MAC key of a third cell group. This third cell group may be associated with a third DU that is controlled by another CU with a different AS root key. Thus, the third MAC key is based on the different AS root key. The CU may provide the UE with information about the third DU to prepare the UE for handover to the third DU. The CU may also provide the UE with information about a MAC security policy. The MAC security policy may indicate which portions of a MAC message that should be protected. The UE may decode MAC messages based on the MAC security policy.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

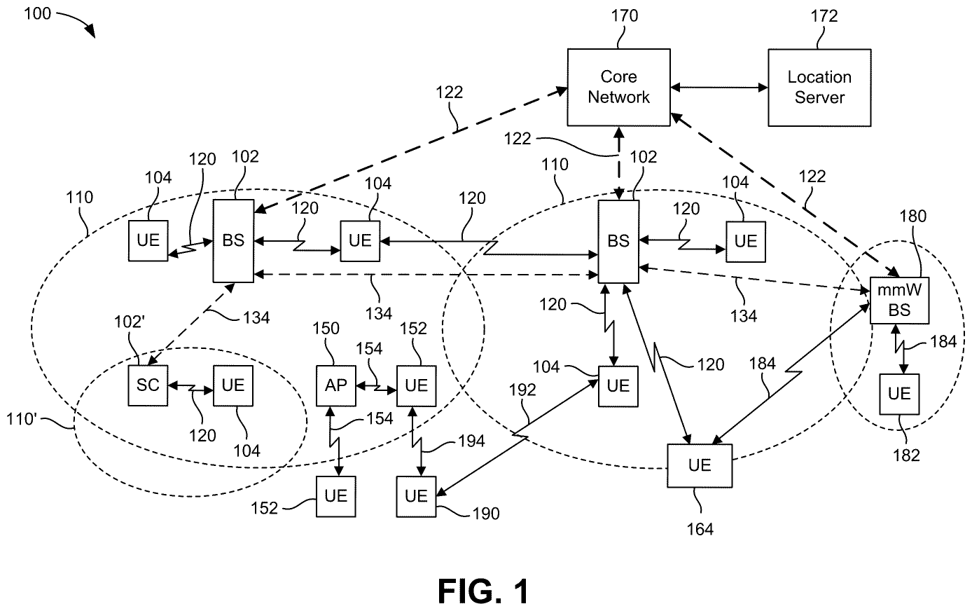

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. The PCI may be a unique identifier for a cell indicated as a part of cell selection. The VCI may be an identifier for a virtual cell that maybe defined for a user based on a set of physical cells. The CGI may be a globally unique identifier representing a cell in a wireless network. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

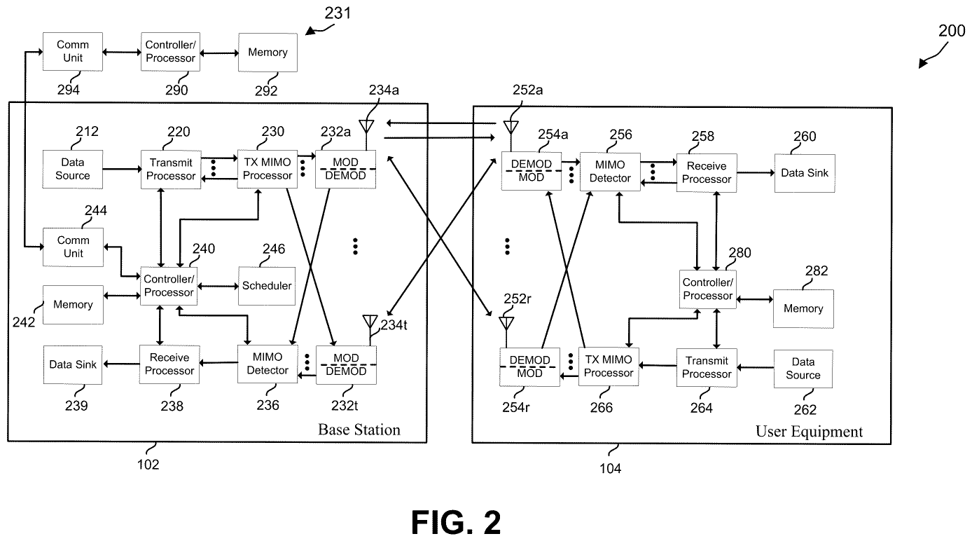

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit uplink control information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU (e.g., centralized wireless node) may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

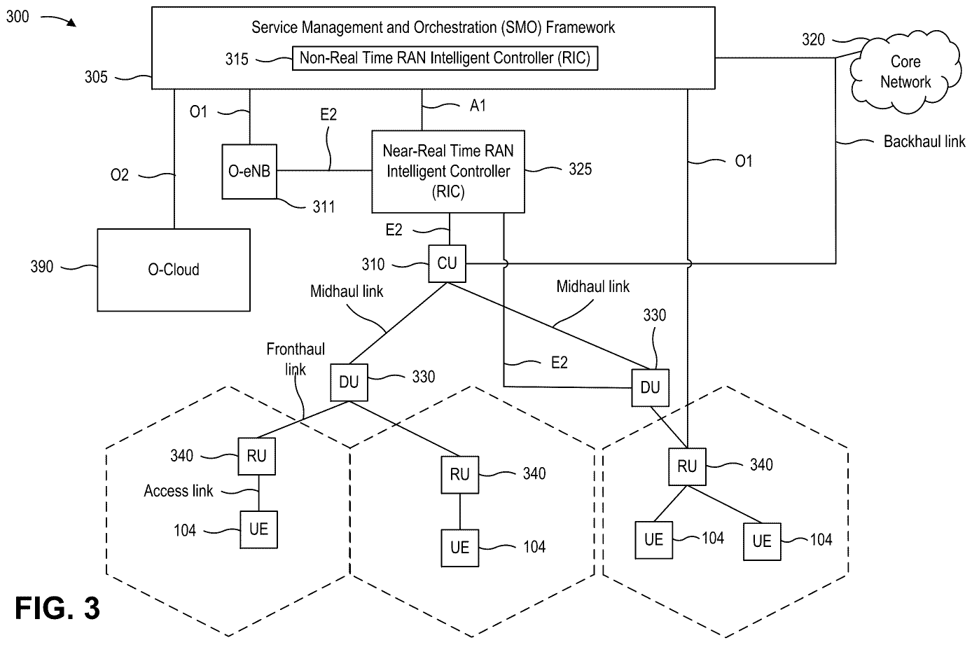

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

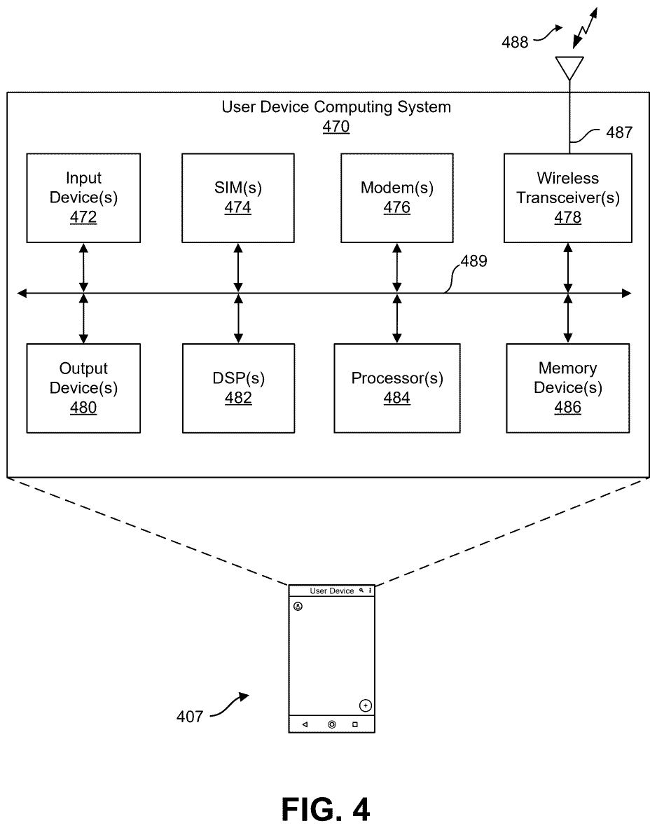

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

As indicated above, a DU may host a MAC layer. The MAC layer may be a protocol layer which manages radio resources for communications between wireless nodes and wireless devices in some wireless networks. For example, the MAC layer may serve to map between logical channels and transport channels, determine resource allocations, such as time/frequence resources, transmission scheduling, and the like. The MAC layer may also include signaling using MAC protocol data units (PDU) The MAC PDU may be a message format for MAC message (e.g., messages of the MAC layer). The MAC PDUs may include multiple MAC subPDUs that carry various messages. For example, MAC PDUs (e.g., MAC subPDUs) may carry time sensitive control information in MAC control element (CE) messages, such as buffer status report (BSR), timing advance commands (TA), transmission configuration indicators (TCI) state activation/deactivation, SCell activation/deactivation, and the like. The MAC subPDUs may also carry PDCP/RLC control PDUs, RRC messages, status reports, and the like. In some cases, the MAC PDUs may not be protected from potential attacks, making them vulnerable to attacks which could degrade and/or disrupt a connection between the wireless node and a wireless device. In some cases, protection may be provided for MAC PDUs using cryptographic keys to encrypt MAC PDUs.

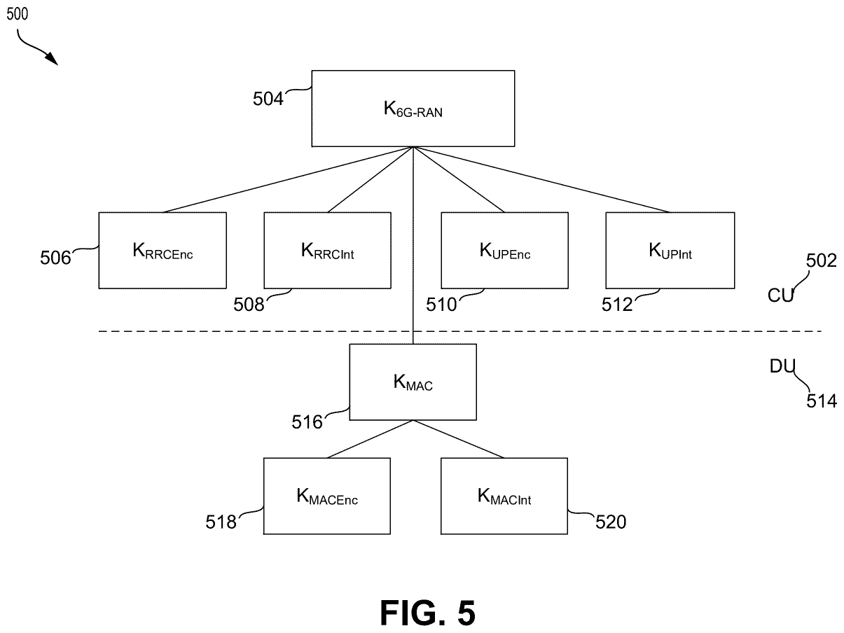

FIG. 5 is a is a tree diagram illustrating a key hierarchy 500 for a wireless system, such as wireless communications network 100, in accordance with aspects of the present disclosure. In some cases, a wireless node, such as a CU 502 (e.g., CU 310 of FIG. 3) may receive an AS root key 504 (K_{6G-RAN}) (e.g., cryptographic key) from which other keys may be derived. In some cases, the AS root key 504 may be an AS security anchor key (K_{CUA}). In some cases, the AS root key 504 may be derived from a key from a core network (e.g., core network 320 of FIG. 3), such as a security service key (K_{SecSvc}). The CU 502 may derive additional keys from the AS root key 504 for services provided by the CU 502, such as an RRC encryption key 506 (K_{RRCEnc}), RRC integrity protection key 508 (RRC_{Int}), UP encryption key 510 (K_{UPEnc}), UP integrity protection key 512 (K_{UPInt}), and the like.

The CU 502 may also derive keys for a DU 514 (e.g., DU 330 of FIG. 3). In some cases, a CU 502 may be connected to multiple DUs, and the CU 502 may derive separate sets of keys for each DU of the multiple DUs. As shown in FIG. 5, the CU 502 may derive, from the AS root key 504, a MAC key 516 (K_{MAC}) (e.g., DU key (K_{DU})) for use with the MAC layer. In some cases, in a CU-DU split architecture (e.g., as in disaggregated base station 300 of FIG. 3), the MAC layer may reside in and be managed by the DU 514. The CU 502 may transmit the MAC key 516 to the DU 514. In some cases, the DU 514 may derive additional keys based on the MAC key 516, such as a MAC encryption key 518 (K_{MACEnc})and/or MAC integrity protection key 520 (K_{MACInt}).

In some cases, the UE may be informed about how to derive the MAC key 516, for example, via RRC signaling. In some cases, a UE may connect to multiple DUs concurrently, such as for dual connectivity, carrier aggregation, and the like. As an example, in dual connectivity, a single CU 502 may be connected to and configure multiple DUs and the UE may access multiple DUs concurrently. In some cases, this may be problematic as the DUs may have separate MAC keys as they are physically separate entities and cannot share MAC keys due to key separation requirements. However, to a UE, the CU-DU split architecture is mostly transparent, and it can be difficult for the UE to determine which DU the UE is communicating with so that the UE can use a correct MAC key.

In some cases, cell groups may be used to distinguish amongst the DUs. In some wireless systems, such as 5G, cell groups may be used for dual connectivity with different types of wireless nodes which share a common core network. For example, the cell group may be a grouping of wireless nodes, such as one or more eNBs configured for 4G/LTE communications in a first cell group. Another grouping of wireless nodes, such as one or more gNBs, in a second cell group may be configured for 5G communications. The first cell group and the second cell group may have a common core network. A UE can distinguish between the first cell group and the second cell group and the UE may communicate with both the first cell group and the second cell group. In some cases, cell groups may be adapted to allow a UE to distinguish between multiple DUs in a CU-DU split architecture to allow for separate MAC keys for the DUs.

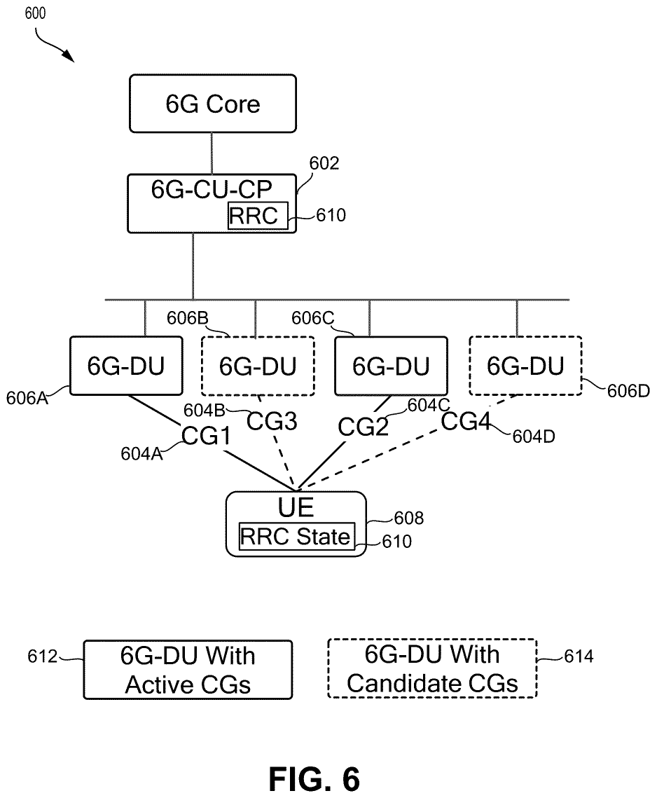

FIG. 6 is a block diagram illustrating cell groups in a wireless network 600, in accordance with aspects of the present disclosure. In some cases, multiple cell groups (CGs) may be defined such that a single configured CG may belong to a specific DU and corresponding CU. Different CGs may belong to different DUs and CUs. For example, a CU 602 may configure a set of CGs (hereinafter, CGs 604), such as CG 1 604A, CG2 604C, CG3 604B, and CG4 604D, and the CGs of the set of CGs may belong to and correspond with various DUs of a set of DUs 606. In FIG. 6, CG1 604A belongs to (e.g., is associated with) DU1 606A CG3 604B belongs to DU2 606B, CG2 604C belongs to DU3 606C, and CG4 604D belongs to DU4 606D. The CGs 604 may also belong to the CU 602. As a part of configuring (e.g., associating) a CG, such as CG1 604A with a DU, such as DU 606A, the CU 602 may prepare (e.g., generate) a MAC key for the CG1 604A and transmit, for example via intracell signaling, the MAC key to the DU 606A. For example, as discussed above, the CU 602 may derive a MAC key for the CG1 based on the AS root key. In some cases, the MAC key may be derived based on a cell group number associated with the cell group (e.g., CG1 604A). The derived MAC key may be transmitted to the corresponding DU 606A. The MAC key may be used to establish a secure connection between a UE 608 and a DU (e.g., DU1 606A) associated with a particular CG (e.g., CG1 604A). In some cases, a single DU may be configured with multiple CGs. In such cases, a separate MAC key may be prepared for each of the multiple CGs configured on the DU. For example, a first MAC key may be used to secure communications between the UE 608 and DU1 606A/CG1 604A and a second MAC key may be used to secure communications between the UE 608 and DU2 606B/CG3 604B.

In some cases, a CG may be configured as an active CG 612 or a candidate CG 614. In some cases, a DU associated with an active CG 612, such as CG1 604A and CG2 604C, may be available for communicating with the UE 608 using protected MAC PDUs. For example, the UE 608 may switch to a DU associated with an active CG 612 and transmit/receive protected MAC PDUs. In some cases, a DU associated with a candidate CG 614 may not be available for communicating with the UE 608 using protected MAC PDUs, but can be made available if the candidate CG 614 is activated (e.g., configured as an active CG 612). A candidate CG 614 may be prepared with a MAC key by the CU 602 prior to be activated.

In some cases, a UE 608 may be configured, e.g., by a CU 602, with the CGs 604 and key derivation parameter(s) for the CGs 604 to generate a per CG MAC key. For example, the UE 608 may receive, from the CU 602, information for deriving a per CG MAC key for a CG associated with a DU. The UE 608 may derive a different MAC key (e.g., MAC key 516) for each CG of the CGs 604. The CU 602 may generate and transmit (e.g., prepare) corresponding MAC keys to the DUs 606. The UE 608 may use an appropriate derived MAC key when accessing a CG of the CGs 604. In some cases, multiple CGs 604 may be accessed concurrently.

In some cases, the UE 608 may be informed about how to derive the MAC keys associated with the CGs 604, for example, using RRC signaling via a RRC connection 610 between the CU 602 and the UE 608. The UE 608 may derive the MAC keys associated with a CG/DU as a part of connecting to the CG/DU. In some cases, the UE 608 may receive a MAC layer message, such as a MAC CE and the UE 608 may decode the MAC CE based on the MAC key. Similarly, the UE 608 may generate a MAC layer message, encode the MAC layer message based on the MAC key, and transmit the encoded MAC layer message to the CG/DU. The CG/DU may receive the encoded MAC layer message from the UE 608, and the CG/DU may decode the encoded MAC layer message using the MAC key. In some cases, an RRC reconfiguration message may be used to indicate information for, support, and/or activation of a MAC PDU protection (e.g., encryption and/or integrity protection of the MAC PDUs based on the MAC keys) pursuant to a MAC security policy. The MAC security policy may be provided to the UE 608, for example, by the CU 602. The MAC security policy may be provided via RRC signaling. The MAC security policy may also be provided to the DUs 606, for example, via intracell signaling. In some cases, the MAC security policy may indicate, for example, what portions of the MAC PDU may be protected. For example, the MAC security policy may indicate that the entire MAC PDU may be protected or individual MAC subPDUs to be protected. The UE 608 and DUs 606 may encode/decode MAC messages based on the MAC security policy.

In some cases, a MAC key (K_{MAC}) may be derived such that K_{MAC}=KDF(K_{6G-RAN}, Param), KDF is a key derivation formula, K_{6G-RAN} is an AS root key (e.g., AS root key 504 of FIG. 5), and Param represents key derivation parameters. The KDF may be a cryptographic algorithm that generates one or more keys based on an input key. In some cases, the key derivation parameters may be based on information about a CG associated with a particular DU. For example, the key derivation parameters may include a cell group number (e.g., a number identifying the cell group). The key derivation parameters for deriving a MAC key may also include other information, such as a string associated with the cell group (e.g., a predefined string, such as “MAC key”), a physical cell ID (PCI) of the logical cell, absolute radio frequency channel number for downlink (ARFCN-DL) channel binding, and the like. In some cases, the key derivation parameters, except for the cell group number, may be common to the CGs 604.

As indicated above, the UE 608 may be informed about (e.g., configured with information about) how to derive a MAC key for the CGs 604. In some cases, the UE 608 may be provided information for deriving the MAC keys for both active CGs and candidate CGs. The information for deriving the MAC keys include the AS root key and key derivation parameters. The UE 608 may derive MAC keys for the active CGs and then derive MAC keys for the candidate CGs when the candidate CGs are activated. In some cases, the CU 602 may prepare the DUs 606 by deriving the MAC keys and providing the derived MAC keys to the DUs 606 corresponding to the CGs 604. In some cases, both active CGs and candidate CGs may be prepared. In some cases, active CGs may be changed (e.g., from CG1 604A and CG2 604C to CG3 604B and CG6 604D) using MAC layer signaling in a manner similar to MAC lower layer triggered mobility (LTM) procedure. For example, CG1 604A and CG2 604C may be deactivated (e.g., changed to candidate CGs) and CG3 604B and CG6 604D may be activated (e.g., changed to active CGs). In some cases, the UE 608 may be provided an indication of which CG is the active CG and/or which CG is the candidate CG. For example, the UE 608 may be provided the indication via an RRC message, a schedule, or via other signaling.

In some cases, the UE 608 may perform a MAC security setup/confirmation procedure to confirm that the UE 608 and corresponding DU have the same MAC key. For example, the UE 608 may derive a MAC key for an active CG 612, such as for CG1 604A. The UE 608 may then receive a MAC layer message, such as a MAC CE. The UE 608 may then attempt to decode the MAC CE based on the MAC key and perform integrity checking on the MAC CE. If the integrity check succeeds, the MAC key is implicitly confirmed. If the integrity check fails, then a MAC security mode command (SMC) may be performed to explicitly confirm the MAC key. In some cases, the MAC SMC may be substantially similar to an AS SMC.

In some cases, the MAC keys may be refreshed by generating a new AS root key (K_{6G-RAN}) for the CU 602 using vertical key derivation. The new AS root key may be vertically derived or horizontally derived. Generating a new AS root key may invalidate all of the MAC keys derived from the AS root key and new MAC keys may be derived from the new AS root key. In such cases, the CU 602 may derive new MAC keys and prepare the DUs 606. The UE may be informed about the new AS root key using RRC signaling, such as via an RRC reconfiguration message. In some cases, a DU may request that the CU 602 refresh the MAC key via vertical key derivation.

Refreshing the MAC keys may also be performed without generating a new AS root key. For example, the MAC keys may be refreshed using horizontal key derivation, for example, by a DU based on the existing MAC key (e.g., current MAC key). For example, the existing MAC key may be input to the KDF to generate the new MAC key such that K_{MAC(Refreshed)}=KDF(K_{MAC(Current)}, Param). The key derivation parameters may remain unchanged. In some cases, the MAC keys may be refreshed using horizontal key derivation based on a predefined schedule, periodically, based on a trigger, etc. In some cases, the DUs 606 may indicate to the UE 608 (e.g., via MAC signaling or RRC reconfiguration) that the MAC keys may be refreshed using horizontal key derivation and the UE 608 may perform horizontal key derivation to refresh the MAC keys.

In some cases, MAC key refresh may be performed using a freshness parameter or freshness counter. For example, a count parameter may be included as a part of the key derivation parameters along with the cell group number. Refreshing the MAC key may then be performed by incrementing the freshness parameter and deriving the new MAC key using the KDF based on the incremented freshness parameter. In some cases, the freshness parameter value may be signaled to the UE 608 (e.g., via MAC signaling or RRC message indicating the MAC key refresh). Similarly, the CU 602 may provide the refreshed MAC keys to the appropriate CG/DUs. The UE 608 may generate a refreshed MAC key, for example, using the freshness parameter/counter, and the UE 608 may communicate with the CG/DU using the refreshed MAC key.

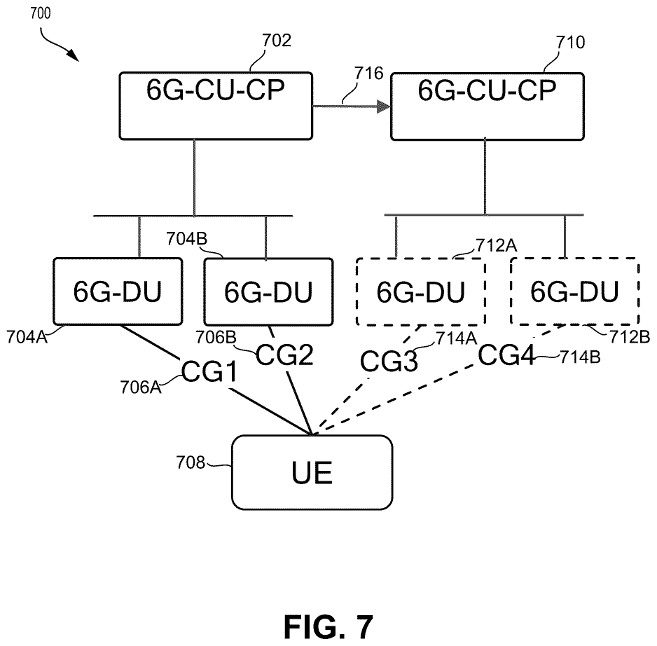

FIG. 7 is a is a block diagram illustrating handover with cell groups in a wireless network 700, in accordance with aspects of the present disclosure. FIG. 7 includes a first CU 702 with a first DU 704A associated with CG1 706A and a second DU 704B associated with CG2 706B. A UE 708 is connected to either the first DU 704A or the second DU 704B. In some cases, the first CU 702 may be preparing to hand over the UE 708 to a second CU 710. The second CU 710 is connected to a third DU 712A associated with CG3 714A and a fourth DU 712B associated with CG4 714B. The third DU 712A/CG3 714A and fourth DU 712B/CG4 714B may have MAC keys derived based on a different AS root key (e.g., from second CU 710), as compared to DU1 704A/CG1 706A and DU2 704B/CG′ 706B. In some cases, during configuration, the first CU 702 may indicate to the UE 708 that the first DU 704A and second DU 704B belong to the first CU 702. The first CU 702 may also indicate to the UE 708 that the third DU 712A and fourth DU 712B belong to a different CU (e.g., the second CU 710). This indication may be sent as a part of configuring the UE 708 or this indication may be sent to prepare the UE 708 for handover to the second CU 710. In some cases, the indication may also include information about CGs associated with the third DU 712A and fourth DU 712B along with key derivation parameters. The key derivation parameters may be determined by the first CU 702, obtained from an AMF/mobility service of the core network, or retrieved from the second CU 710. The first CU 702 may also transmit a request 716 to the second CU 710 requesting the second CU 710 prepare the third DU 712A and fourth DU 712B and associated CG3 714A and CG4 714B with MAC keys. The UE may also receive an AS root key 504 associated with the second CU 710. In some cases, the AS root key 504 may be received via RRC signaling, such as in a RRC reconfiguration message, from the second CU 710. The UE 708 may then be able to derive MAC keys associated with the third DU 712A/CG3 714A and the fourth DU 712B/CG4 714B.

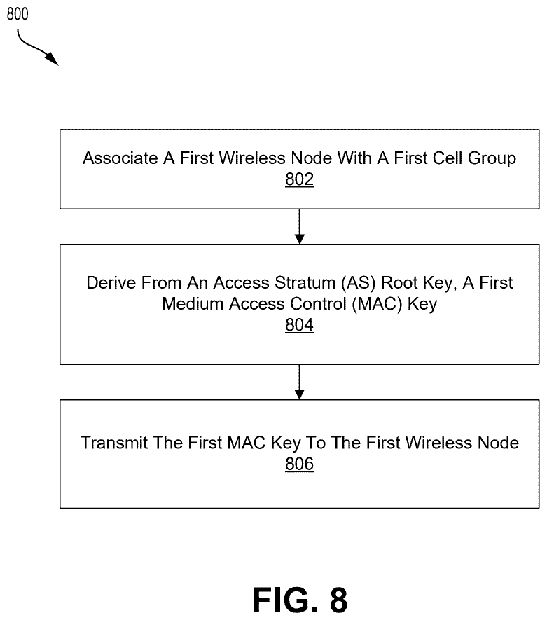

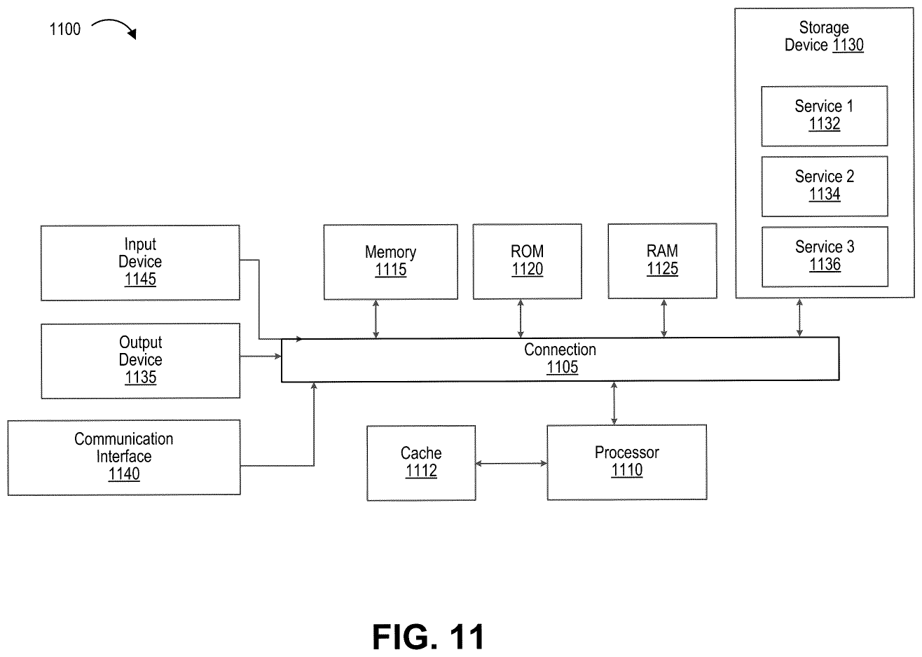

FIG. 8 is a flow diagram illustrating a process 800 for communicating with a wireless system, in accordance with aspects of the present disclosure. The process 800 can be performed by a component or system (e.g., a chipset, server, device, etc.) of a wireless network (e.g., BS 102, mmW BS 180, core network 170 of FIG. 1, core network 320 of FIG. 3, SMO Framework 305 of FIG. 3, O-eNB 311 of FIG. 3, RIC 325 of FIG. 3, O-Cloud 390 of FIG. 3, CU 310 of FIG. 3, DU 330 of FIG. 3, CU 602 of FIG. 6, DUs 606 of FIG. 6, CU 702 of FIG. 7, CU 710 of FIG. 7, DUs 704A, 704B, 712A, and 712B of FIG. 7, computing system 1100 of FIG. 11, etc.). The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device (e.g., UE 104, of FIGS. 1 and 2, respectively, wireless device 407 of FIG. 4, UE 608 of FIG. 6, UE 708 of FIG. 7, computing system 1100 of FIG. 11, etc.). The operations of the process 800 may be implemented as software components that are executed and run on one or more processors (e.g., processor 1110 of FIG. 11 or other processor(s)). Further, the transmission and reception of signals by the wireless network (or component of the wireless network, such as the security service) in the process 800 may be enabled, for example, by one or more antennas (e.g., antennas 234 of FIG.) and/or one or more transceivers (e.g., modulators/demodulators 232, TX MIMO processor 230, MIMO detector 236, transmit processor 220, receive processor 238 of FIG. 2, etc.).

At block 802, the computing device (or component thereof) may associate a first wireless node (e.g., DU 330 of FIG. 3, DUs 606 of FIG. 6, CU 710 of FIG. 7, DUs 704A, 704B, 712A, and 712B of FIG. 7) with a first cell group (e.g., CGs 604 of FIG. 6, CGs 706 of FIG. 7). For example, a CU, such as CU 602 of FIG. 6) may associate a CG 9 e.g., CG1 604A of FIG. 6), of a set of CGs (e.g., CGs 604), with a DU (e.g., DU 606A of FIG. 6) of a set of DUs (e.g., DUs 606).

At block 804, the computing device (or component thereof) may derive from an access stratum (AS) root key (e.g., AS root key 504 of FIG. 5), a first medium access control (MAC) key (e.g., MAC key 516 of FIG. 5). In some cases, the first MAC key is based on a first cell group number associated with the first cell group. In some cases, the computing device (or component thereof) may provide, to the wireless device, key derivation parameters for a third MAC key of a third cell group (e.g., CG3 714A of FIG. 7), wherein the third cell group is associated with a third wireless node (e.g., third DU 712A of FIG. 7), and wherein third MAC key is based on a different AS root key. In some examples, a MAC key is derived based on at least one of: a string associated with the first cell group, a physical cell identifier, an absolute radio frequency channel number for downlink channel binding, or a freshness parameter. In some cases, the computing device (or component thereof) may provide the wireless device: an indication of a MAC security policy, wherein the MAC security policy indicates portions of a MAC message to be protected

At block 806, the computing device (or component thereof) may transmit the first MAC key to the first wireless node, wherein the first MAC key secures MAC messages between the first wireless node and a wireless device. In some cases, the computing device (or component thereof) may associate a second wireless node with a second cell group; derive from the AS root key, a second MAC key based on a second cell group number associated with the second cell group, wherein the first MAC key is different from the second MAC key; and transmit the second MAC key to the second wireless node. In some examples, the first wireless node and the second wireless node are associated with a same centralized wireless node (e.g., CU 310 of FIG. 3, CU 602 of FIG. 6, CU 702 of FIG. 7, CU 710 of FIG. 7, etc.). In some cases, the second MAC key secures MAC messages between the second wireless node and the wireless device. In some examples, the first cell group is configured as an active cell group (e.g., active CG 612 of FIG. 6), wherein the second cell group is configured as a candidate cell group (e.g., candidate CG 614 of FIG. 6), and wherein the processor is further configured to provide an indication to the wireless device of the active cell group and the candidate cell group. For example, the UE may be provided an indication of which CG is the active CG and/or which CG is the candidate CG. In some cases, the first wireless node is associated with multiple cell groups, and wherein the first wireless node and second wireless node comprise one wireless node. In some examples, the computing device (or component thereof) may refresh the first MAC key based on at least one of the first MAC key, or the freshness parameter

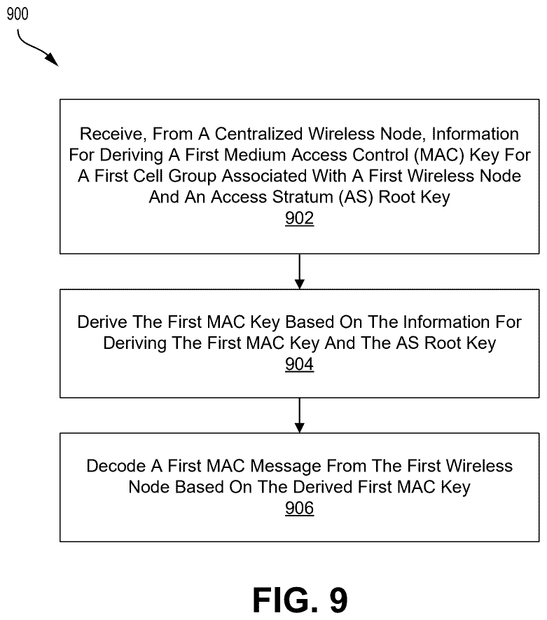

FIG. 9 is a flow diagram illustrating a process 900 for communicating with a wireless system, in accordance with aspects of the present disclosure. The process 900 can be performed by a component or system (e.g., a chipset, server, device, etc.) of a wireless device (e.g., UE 104, of FIGS. 1 and 2, respectively, wireless device 407 of FIG. 4, UE 608 of FIG. 6, UE 708 of FIG. 7, computing system 1100 of FIG. 11, etc.). The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The wireless device may communicate with a wireless network, or components thereof (e.g., BS 102, mmW BS 180, core network 170 of FIG. 1, core network 320 of FIG. 3, SMO Framework 305 of FIG. 3, O-eNB 311 of FIG. 3, RIC 325 of FIG. 3, O-Cloud 390 of FIG. 3, CU 310 of FIG. 3, DU 330 of FIG. 3, CU 602 of FIG. 6, DUs 606 of FIG. 6, CU 702 of FIG. 7, CU 710 of FIG. 7, DUs 704A, 704B, 712A, and 712B of FIG. 7, computing system 1100 of FIG. 11, etc.). The operations of the process 900 may be implemented as software components that are executed and run on one or more processors (e.g., processor 1110 of FIG. 11 or other processor(s)). Further, the transmission and reception of signals by the wireless device (or component of the wireless device) in the process 900 may be enabled, for example, by one or more antennas (e.g., antennas 252 of FIG.) and/or one or more transceivers (e.g., modulators/demodulators 254, TX MIMO processor 266, MIMO detector 256, transmit processor 264, receive processor 258 of FIG. 2, etc.).

At block 902, the computing device (or component thereof) may receive, from a centralized wireless node (e.g., CU 310 of FIG. 3, CU 602 of FIG. 6, CU 702 of FIG. 7, CU 710 of FIG. 7, etc.), information for deriving a first medium access control (MAC) key (e.g., MAC key 516 of FIG. 5) for a first cell group (e.g., CGs 604 of FIG. 6, CGs 706 of FIG. 7) associated with a first wireless node and an access stratum (AS) root key (e.g., AS root key 504 of FIG. 5). For example, a UE may receive, from the CU, information for deriving a per CG MAC key for a CG associated with a DU. In some cases, the computing device (or component thereof) may receive an indication of a MAC security policy, wherein the MAC security policy indicates portions of a MAC message to be protected; and decode the first MAC message based on the MAC security policy.

At block 904, the computing device (or component thereof) may derive the first MAC key based on the information for deriving the first MAC key and the AS root key. For example, the UE may derive a different MAC key for each CG. In some cases, the computing device (or component thereof) may receive key derivation parameters for a third MAC key of a third cell group (e.g., CG3 714A of FIG. 7), wherein the third cell group is associated with a third wireless node (e.g., third DU 712A of FIG. 7), and wherein third MAC key is based on a different AS root key; and decode a second MAC message from the third wireless node based on the third MAC key after handing over to the third wireless node. In some examples. a MAC key is derived based on at least one of: a string associated with the first cell group, a physical cell identifier, an absolute radio frequency channel number for downlink channel binding, or a freshness parameter. In some cases, the computing device (or component thereof) may receive an indication to refresh the first MAC key; and refresh the first MAC key based on at least one of the first MAC key, or the freshness parameter. For example, the DUs may indicate to the UE (e.g., via MAC signaling or RRC reconfiguration) that the MAC keys may be refreshed using horizontal key derivation and the UE may perform horizontal key derivation to refresh the MAC keys.

At block 906, the computing device (or component thereof) may decode a first MAC message from the first wireless node based on the derived first MAC key. For example, the UE may receive a MAC layer message, such as a MAC CE and the UE may decode the MAC CE based on the MAC key. In some cases, the computing device (or component thereof) may receive, from the centralized wireless node, information for deriving a second MAC key for a second cell group associated with a second wireless node; derive the second MAC key; and decode a second MAC message from the second wireless node based on the derived second MAC key. In some examples, the first wireless node and the second wireless node are associated with a same centralized wireless node. In some cases, the first cell group is configured as an active cell group (e.g., active CG 612 of FIG. 6), wherein the second cell group is configured as a candidate cell group (e.g., candidate CG 614 of FIG. 6), and wherein the processor is further configured to receive an indication of the active cell group and the candidate cell group. For example, the UE may receive an indication of which CG is the active CG and/or which CG is the candidate CG. In some cases, the computing device (or component thereof) may encode a second MAC message based on the first MAC key for transmission to the first wireless node. For example, the UE may generate a MAC layer message, encode the MAC layer message based on the MAC key, and transmit the encoded MAC layer message to the CG/DU.

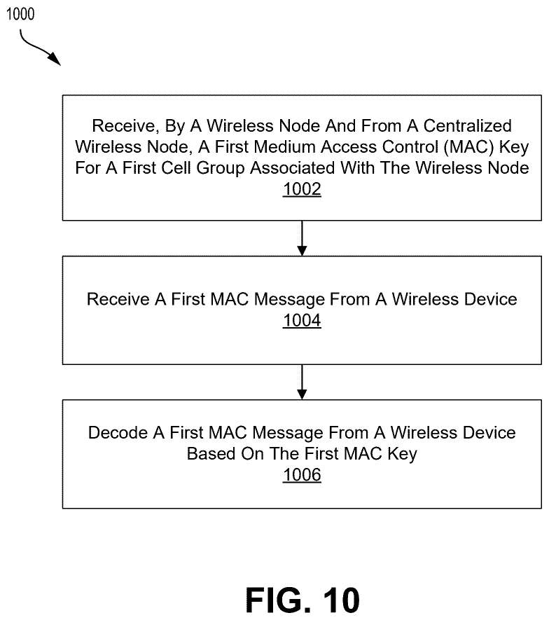

FIG. 10 is a flow diagram illustrating a process 1000 for communicating with a wireless system, in accordance with aspects of the present disclosure. The process 1000 can be performed by a component or system (e.g., a chipset, server, device, etc.) of a wireless device (e.g., UE 104, of FIGS. 1 and 2, respectively, wireless device 407 of FIG. 4, UE 608 of FIG. 6, UE 708 of FIG. 7, computing system 1100 of FIG. 11, etc.). The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The wireless device may communicate with a wireless network, or components thereof (e.g., BS 102, mmW BS 180, core network 170 of FIG. 1, core network 320 of FIG. 3, SMO Framework 305 of FIG. 3, O-eNB 311 of FIG. 3, RIC 325 of FIG. 3, O-Cloud 390 of FIG. 3, CU 310 of FIG. 3, DU 330 of FIG. 3, CU 602 of FIG. 6, DUs 606 of FIG. 6, CU 702 of FIG. 7, CU 710 of FIG. 7, DUs 704A, 704B, 712A, and 712B of FIG. 7, computing system 1100 of FIG. 11, etc.). The operations of the process 1000 may be implemented as software components that are executed and run on one or more processors (e.g., processor 1110 of FIG. 11 or other processor(s)). Further, the transmission and reception of signals by the wireless device (or component of the wireless device) in the process 1000 may be enabled, for example, by one or more antennas (e.g., antennas 252 of FIG.) and/or one or more transceivers (e.g., modulators/demodulators 254, TX MIMO processor 266, MIMO detector 256, transmit processor 264, receive processor 258 of FIG. 2, etc.).

At block 1002, the computing device (or component thereof) may receive, from a centralized wireless node (e.g., CU 310 of FIG. 3, CU 602 of FIG. 6, CU 702 of FIG. 7, CU 710 of FIG. 7, etc.), a first medium access control (MAC) key (e.g., MAC key 516 of FIG. 5) for a first cell group (e.g., CGs 604 of FIG. 6, CGs 706 of FIG. 7). For example, a CU may prepare (e.g., generate) a MAC key for the CG and transmit, for example via intracell signaling, the MAC key to the DU associated with the CG. In some cases, a MAC key is derived based on at least one of: a string associated with the first cell group, a physical cell identifier, an absolute radio frequency channel number for downlink channel binding, or a freshness parameter. In some cases, the computing device (or component thereof) may receive an indication of a MAC security policy, wherein the MAC security policy indicates portions of a MAC message to be protected; and decode the first MAC message based on the MAC security policy.

At block 1004, the computing device (or component thereof) may receive a first MAC message from a wireless device. For example, a CG/DU may receive the encoded MAC layer message from a UE and the CG/DU may decode the encoded MAC layer message using the MAC key.

At block 1006, the computing device (or component thereof) may decode the first MAC message from a wireless device based on the first MAC key. For example, the CG/DU may decode the encoded MAC layer message using the MAC key In some cases, the computing device (or component thereof) may receive, from the centralized wireless node, a second MAC key for a second cell group associated with the wireless node, wherein the wireless node is associated with multiple cell groups; receive a second MAC message from the wireless device; and decode a second MAC message from the wireless node based on the second MAC key. In some examples, the first cell group is configured as an active cell group, wherein the second cell group is configured as a candidate cell group, and wherein the processor is further configured to receive an indication of the active cell group and the candidate cell group. In some cases, the computing device (or component thereof) may receive a refreshed MAC key; and communicate with the wireless node using the refreshed MAC key. In some examples, the computing device (or component thereof) may encode a second MAC message based on the first MAC key for transmission to the wireless device.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 800, process 900, process 1000, and/or other processes described herein may include a processor, microprocessor, micro-computer, or other component of a device that is configured to carry out the steps of the process 800, process 900, process 1000, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 800, process 900, process 1000, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The processes 800, 900, and 1000 are illustrated as a logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 800, process 900, process 1000, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present technology. In particular, FIG. 11 illustrates an example of computing system 1100, which may be for example any computing device making up internal computing system, a remote computing system, a camera, or any component thereof in which the components of the system are in communication with each other using connection 1105. Connection 1105 may be a physical connection using a bus, or a direct connection into processor 1110, such as in a chipset architecture. Connection 1105 may also be a virtual connection, networked connection, or logical connection.

In some embodiments, computing system 1100 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1100 includes at least one processing unit (CPU or processor) 1110 and connection 1105 that communicatively couples various system components including system memory 1115, such as read-only memory (ROM) 1120 and random access memory (RAM) 1125 to processor 1110. Computing system 1100 may include a cache 1112 of high-speed memory connected directly with, in close proximity to, or integrated as part of processor 1110.

Processor 1110 may include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which may represent any number of input mechanisms, such as a microphone for speech, a touch-sensitive screen for gesture or graphical input, keyboard, mouse, motion input, speech, etc. Computing system 1100 may also include output device 1135, which may be one or more of a number of output mechanisms. In some instances, multimodal systems may enable a user to provide multiple types of input/output to communicate with computing system 1100.

Computing system 1100 may include communications interface 1140, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 may include software services, servers, services, etc., that when the code that defines such software is executed by the processor 1110, it causes the system to perform a function. In some embodiments, a hardware service that performs a particular function may include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for communicating with a wireless network, comprising: a memory; a processor coupled to the memory and configured to: associate a first wireless node with a first cell group; derive from an access stratum (AS) root key, a first medium access control (MAC) key, wherein the first MAC key is based on a first cell group number associated with the first cell group; and transmit the first MAC key to the first wireless node, wherein the first MAC key secures MAC messages between the first wireless node and a wireless device.

Aspect 2. The apparatus of Aspect 1, wherein the processor is further configured to: associate a second wireless node with a second cell group, wherein the first wireless node and the second wireless node are associated with a same centralized wireless node; derive from the AS root key, a second MAC key based on a second cell group number associated with the second cell group, wherein the first MAC key is different from the second MAC key; and transmit the second MAC key to the second wireless node, wherein the second MAC key secures MAC messages between the second wireless node and the wireless device.

Aspect 3. The apparatus of Aspect 2, wherein the first cell group is configured as an active cell group, wherein the second cell group is configured as a candidate cell group, and wherein the processor is further configured to provide an indication to the wireless device of the active cell group and the candidate cell group.

Aspect 4. The apparatus of any of Aspects 2-3, wherein the first wireless node is associated with multiple cell groups, and wherein the first wireless node and second wireless node comprise one wireless node.

Aspect 5. The apparatus of any of Aspects 1-4, wherein the processor is further configured to provide, to the wireless device, key derivation parameters for a third MAC key of a third cell group, wherein the third cell group is associated with a third wireless node, and wherein third MAC key is based on a different AS root key.

Aspect 6. The apparatus of any of Aspects 1-5, wherein a MAC key is derived based on at least one of: a string associated with the first cell group, a physical cell identifier, an absolute radio frequency channel number for downlink channel binding, or a freshness parameter.

Aspect 7. The apparatus of Aspect 6, wherein the processor is further configured to: refresh the first MAC key based on at least one of the first MAC key, or the freshness parameter.

Aspect 8. The apparatus of any of Aspects 1-7, wherein the processor is further configured to provide the wireless device: an indication of a MAC security policy, wherein the MAC security policy indicates portions of a MAC message to be protected.

Aspect 9. An apparatus for communicating with a wireless network, comprising: a memory; a processor coupled to the memory and configured to: receive, from a centralized wireless node, information for deriving a first medium access control (MAC) key for a first cell group associated with a first wireless node and an access stratum (AS) root key; derive the first MAC key based on the information for deriving the first MAC key and the AS root key; and decode a first MAC message from the first wireless node based on the derived first MAC key.

Aspect 10. The apparatus of Aspect 9, wherein the processor is further configured to: receive, from the centralized wireless node, information for deriving a second MAC key for a second cell group associated with a second wireless node, wherein the first wireless node and the second wireless node are associated with a same centralized wireless node; derive the second MAC key; and decode a second MAC message from the second wireless node based on the derived second MAC key.

Aspect 11. The apparatus of Aspect 10, wherein the first cell group is configured as an active cell group, wherein the second cell group is configured as a candidate cell group, and wherein the processor is further configured to receive an indication of the active cell group and the candidate cell group.

Aspect 12. The apparatus of any of Aspects 9-11, wherein the processor is further configured to: receive key derivation parameters for a third MAC key of a third cell group, wherein the third cell group is associated with a third wireless node, and wherein third MAC key is based on a different AS root key; and decode a second MAC message from the third wireless node based on the third MAC key after handing over to the third wireless node.

Aspect 13. The apparatus of any of Aspects 9-12, wherein a MAC key is derived based on at least one of: a string associated with the first cell group, a physical cell identifier, an absolute radio frequency channel number for downlink channel binding, or a freshness parameter.

Aspect 14. The apparatus of Aspect 13, wherein the processor is further configured to: receive an indication to refresh the first MAC key; and refresh the first MAC key based on at least one of the first MAC key, or the freshness parameter.

Aspect 15. The apparatus of any of Aspects 9-14, wherein the processor is further configured to: receive an indication of a MAC security policy, wherein the MAC security policy indicates portions of a MAC message to be protected; and decode the first MAC message based on the MAC security policy.

Aspect 16. The apparatus of any of Aspects 9-15, wherein the processor is further configured to encode a second MAC message based on the first MAC key for transmission to the first wireless node.

Aspect 17. An apparatus for communicating with a wireless network, comprising: a memory; a processor coupled to the memory and configured to: receive, from a centralized wireless node, a first medium access control (MAC) key for a first cell group; receive a first MAC message from a wireless device; and decode a first MAC message from a wireless device based on the first MAC key.

Aspect 18. The apparatus of Aspect 17, wherein the processor is further configured to: receive, from the centralized wireless node, a second MAC key for a second cell group associated with the wireless node, wherein the wireless node is associated with multiple cell groups; receive a second MAC message from the wireless device; and decode a second MAC message from the wireless node based on the second MAC key.

Aspect 19. The apparatus of Aspect 18, wherein the first cell group is configured as an active cell group, wherein the second cell group is configured as a candidate cell group, and wherein the processor is further configured to receive an indication of the active cell group and the candidate cell group.

Aspect 20. The apparatus of any of Aspects 17-19, wherein a MAC key is derived based on at least one of: a string associated with the first cell group, a physical cell identifier, an absolute radio frequency channel number for downlink channel binding, or a freshness parameter.

Aspect 21. The apparatus of Aspect 20, wherein the processor is further configured to: receive a refreshed MAC key; and communicate with the wireless node using the refreshed MAC key.

Aspect 22. The apparatus of any of Aspects 17-21, wherein the processor is further configured to: receive an indication of a MAC security policy, wherein the MAC security policy indicates portions of a MAC message to be protected; and decode the first MAC message based on the MAC security policy.

Aspect 23. The apparatus of any of Aspects 17-22, wherein the processor is further configured to encode a second MAC message based on the first MAC key for transmission to the wireless device.

Aspect 24. A method for communicating with a wireless network, comprising: associating a first wireless node with a first cell group; deriving from an access stratum (AS) root key, a first medium access control (MAC) key, wherein the first MAC key is based on a first cell group number associated with the first cell group; and transmitting the first MAC key to the first wireless node, wherein the first MAC key secures MAC messages between the first wireless node and a wireless device.

Aspect 25. The method of Aspect 24, further comprising: associating a second wireless node with a second cell group, wherein the first wireless node and the second wireless node are associated with a same centralized wireless node; deriving from the AS root key, a second MAC key based on a second cell group number associated with the second cell group, wherein the first MAC key is different from the second MAC key; and transmitting the second MAC key to the second wireless node, wherein the second MAC key secures MAC messages between the second wireless node and the wireless device.

Aspect 26. The method of Aspect 25, wherein the first cell group is configured as an active cell group, wherein the second cell group is configured as a candidate cell group, and further comprising providing an indication to the wireless device of the active cell group and the candidate cell group.

Aspect 27. The method of any of Aspects 25-26, wherein the first wireless node is associated with multiple cell groups, and wherein the first wireless node and second wireless node comprise one wireless node.

Aspect 28. The method of any of Aspects 24-27, further comprising providing, to the wireless device, key derivation parameters for a third MAC key of a third cell group, wherein the third cell group is associated with a third wireless node, and wherein third MAC key is based on a different AS root key.

Aspect 29. The method of any of Aspects 24-28, wherein a MAC key is derived based on at least one of: a string associated with the first cell group, a physical cell identifier, an absolute radio frequency channel number for downlink channel binding, or a freshness parameter.

Aspect 30. The method of Aspect 29, further comprising: refreshing the first MAC key based on at least one of the first MAC key, or the freshness parameter.

Aspect 31. The method of any of Aspects 24-30, further comprising providing the wireless device: an indication of a MAC security policy, wherein the MAC security policy indicates portions of a MAC message to be protected.

Aspect 32. A method for communicating with a wireless network, comprising: receiving, from a centralized wireless node, information for deriving a first medium access control (MAC) key for a first cell group associated with a first wireless node and an access stratum (AS) root key; deriving the first MAC key based on the information for deriving the first MAC key and the AS root key; and decoding a first MAC message from the first wireless node based on the derived first MAC key.

Aspect 33. The method of Aspect 32, further comprising: receiving, from the centralized wireless node, information for deriving a second MAC key for a second cell group associated with a second wireless node, wherein the first wireless node and the second wireless node are associated with a same centralized wireless node; deriving the second MAC key; and decoding a second MAC message from the second wireless node based on the derived second MAC key.

Aspect 34. The method of Aspect 33, wherein the first cell group is configured as an active cell group, wherein the second cell group is configured as a candidate cell group, and further comprising receiving an indication of the active cell group and the candidate cell group.

Aspect 35. The method of any of Aspects 32-34, further comprising: receiving key derivation parameters for a third MAC key of a third cell group, wherein the third cell group is associated with a third wireless node, and wherein third MAC key is based on a different AS root key; and decoding a second MAC message from the third wireless node based on the third MAC key after handing over to the third wireless node.

Aspect 36. The method of any of Aspects 32-35, wherein a MAC key is derived based on at least one of: a string associated with the first cell group, a physical cell identifier, an absolute radio frequency channel number for downlink channel binding, or a freshness parameter.

Aspect 37. The method of Aspect 36, further comprising: receiving an indication to refresh the first MAC key; and refreshing the first MAC key based on at least one of the first MAC key, or the freshness parameter.

Aspect 38. The method of any of Aspects 32-37, further comprising: receiving an indication of a MAC security policy, wherein the MAC security policy indicates portions of a MAC message to be protected; and decoding the first MAC message based on the MAC security policy.

Aspect 39. The method of any of Aspects 32-38, further comprising encoding a second MAC message based on the first MAC key for transmission to the first wireless node.

Aspect 40. A method for communicating with a wireless network, comprising: receiving, by a wireless node and from a centralized wireless node, a first medium access control (MAC) key for a first cell group associated with the wireless node; receiving a first MAC message from a wireless device; and decoding the first MAC message from a wireless device based on the first MAC key.

Aspect 41. The method of Aspect 40, further comprising: receiving, from the centralized wireless node, a second MAC key for a second cell group associated with the wireless node, wherein the wireless node is associated with multiple cell groups; receiving a second MAC message from the wireless device; and decoding a second MAC message from the wireless node based on the second MAC key.

Aspect 42. The method of Aspect 41, wherein the first cell group is configured as an active cell group, wherein the second cell group is configured as a candidate cell group, and further comprising receiving an indication of the active cell group and the candidate cell group.

Aspect 43. The method of any of Aspects 40-42, wherein a MAC key is derived based on at least one of: a string associated with the first cell group, a physical cell identifier, an absolute radio frequency channel number for downlink channel binding, or a freshness parameter.

Aspect 44. The method of Aspect 43, further comprising: receiving a refreshed MAC key; and communicating with the wireless node using the refreshed MAC key.

Aspect 45. The method of any of Aspects 40-44, further comprising: receiving an indication of a MAC security policy, wherein the MAC security policy indicates portions of a MAC message to be protected; and decoding the first MAC message based on the MAC security policy.

Aspect 46. The method of any of Aspects 40-45, further comprising encoding a second MAC message based on the first MAC key for transmission to the wireless device.

Aspect 47. A non-transitory computer-readable medium having stored thereon instructions that, when executed by a processor, cause the processor to perform operations according to any of Aspects 24-31.

Aspect 48. An apparatus for communicating with a wireless network comprising one or more means for performing operations according to any of Aspects 24-31.

Aspect 49. A non-transitory computer-readable medium having stored thereon instructions that, when executed by a processor, cause the processor to perform operations according to any of Aspects 32-39.

Aspect 50. An apparatus for communicating with a wireless network comprising one or more means for performing operations according to any of Aspects 32-39.

Aspect 51. A non-transitory computer-readable medium having stored thereon instructions that, when executed by a processor, cause the processor to perform operations according to any of Aspects 40-46.

Aspect 52. An apparatus for communicating with a wireless network comprising one or more means for performing operations according to any of Aspects 40-46.

What is claimed is:

1. An apparatus for communicating with a wireless network, comprising:
a memory; and
a processor coupled to the memory and configured to:
associate a first wireless node with a first cell group;
derive from an access stratum (AS) root key, a first medium access control (MAC) key, wherein the first MAC key is based on a first cell group number associated with the first cell group; and
transmit the first MAC key to the first wireless node, wherein the first MAC key secures MAC messages between the first wireless node and a wireless device.

2. The apparatus of claim 1, wherein the processor is further configured to:
associate a second wireless node with a second cell group, wherein the first wireless node and the second wireless node are associated with a same centralized wireless node;
derive from the AS root key, a second MAC key based on a second cell group number associated with the second cell group, wherein the first MAC key is different from the second MAC key; and
transmit the second MAC key to the second wireless node, wherein the second MAC key secures MAC messages between the second wireless node and the wireless device.

3. The apparatus of claim 2, wherein the first cell group is configured as an active cell group, wherein the second cell group is configured as a candidate cell group, and wherein the processor is further configured to provide an indication to the wireless device of the active cell group and the candidate cell group.

4. The apparatus of claim 2, wherein the first wireless node is associated with multiple cell groups, and wherein the first wireless node and second wireless node comprise one wireless node.

5. The apparatus of claim 1, wherein the processor is further configured to provide, to the wireless device, key derivation parameters for a third MAC key of a third cell group, wherein the third cell group is associated with a third wireless node, and wherein third MAC key is based on a different AS root key.

6. The apparatus of claim 1, wherein a MAC key is derived based on at least one of:
a string associated with the first cell group,
a physical cell identifier,
an absolute radio frequency channel number for downlink channel binding, or
a freshness parameter.

7. The apparatus of claim 6, wherein the processor is further configured to: refresh the first MAC key based on at least one of the first MAC key, or the freshness parameter.

8. The apparatus of claim 1, wherein the processor is further configured to provide the wireless device: an indication of a MAC security policy, wherein the MAC security policy indicates portions of a MAC message to be protected.

9. An apparatus for communicating with a wireless network, comprising:
a memory; and
a processor coupled to the memory and configured to:
receive, from a centralized wireless node, information for deriving a first medium access control (MAC) key for a first cell group associated with a first wireless node and an access stratum (AS) root key;
derive the first MAC key based on the information for deriving the first MAC key and the AS root key; and
decode a first MAC message from the first wireless node based on the derived first MAC key.

10. The apparatus of claim 9, wherein the processor is further configured to:
receive, from the centralized wireless node, information for deriving a second MAC key for a second cell group associated with a second wireless node, wherein the first wireless node and the second wireless node are associated with a same centralized wireless node;
derive the second MAC key; and
decode a second MAC message from the second wireless node based on the derived second MAC key.

11. The apparatus of claim 10, wherein the first cell group is configured as an active cell group, wherein the second cell group is configured as a candidate cell group, and wherein the processor is further configured to receive an indication of the active cell group and the candidate cell group.

12. The apparatus of claim 9, wherein the processor is further configured to:
receive key derivation parameters for a third MAC key of a third cell group, wherein the third cell group is associated with a third wireless node, and wherein third MAC key is based on a different AS root key; and
decode a second MAC message from the third wireless node based on the third MAC key after handing over to the third wireless node.

13. The apparatus of claim 9, wherein a MAC key is derived based on at least one of:
a string associated with the first cell group,
a physical cell identifier,
an absolute radio frequency channel number for downlink channel binding, or
a freshness parameter.

14. The apparatus of claim 13, wherein the processor is further configured to:
receive an indication to refresh the first MAC key; and
refresh the first MAC key based on at least one of the first MAC key, or the freshness parameter.

15. The apparatus of claim 9, wherein the processor is further configured to:
receive an indication of a MAC security policy, wherein the MAC security policy indicates portions of a MAC message to be protected; and
decode the first MAC message based on the MAC security policy.

16. The apparatus of claim 9, wherein the processor is further configured to encode a second MAC message based on the first MAC key for transmission to the first wireless node.

17. A method for communicating with a wireless network, comprising:
associating a first wireless node with a first cell group;
deriving from an access stratum (AS) root key, a first medium access control (MAC) key, wherein the first MAC key is based on a first cell group number associated with the first cell group; and
transmitting the first MAC key to the first wireless node, wherein the first MAC key secures MAC messages between the first wireless node and a wireless device.

18. The method of claim 17, further comprising:
associating a second wireless node with a second cell group, wherein the first wireless node and the second wireless node are associated with a same centralized wireless node;
deriving from the AS root key, a second MAC key based on a second cell group number associated with the second cell group, wherein the first MAC key is different from the second MAC key; and
transmitting the second MAC key to the second wireless node, wherein the second MAC key secures MAC messages between the second wireless node and the wireless device.

19. The method of claim 18, wherein the first cell group is configured as an active cell group, wherein the second cell group is configured as a candidate cell group, and further comprising providing an indication to the wireless device of the active cell group and the candidate cell group.

20. The method of claim 18, wherein the first wireless node is associated with multiple cell groups, and wherein the first wireless node and second wireless node comprise one wireless node.

21. The method of claim 17, further comprising providing, to the wireless device, key derivation parameters for a third MAC key of a third cell group, wherein the third cell group is associated with a third wireless node, and wherein third MAC key is based on a different AS root key.

22. The method of claim 17, wherein a MAC key is derived based on at least one of:
a string associated with the first cell group,
a physical cell identifier,
an absolute radio frequency channel number for downlink channel binding, or
a freshness parameter.

23. The method of claim 22, further comprising: refreshing the first MAC key based on at least one of the first MAC key, or the freshness parameter.

24. The method of claim 17, further comprising providing the wireless device: an indication of a MAC security policy, wherein the MAC security policy indicates portions of a MAC message to be protected.

25. A method for communicating with a wireless network, comprising:
receiving, from a centralized wireless node, information for deriving a first medium access control (MAC) key for a first cell group associated with a first wireless node and an access stratum (AS) root key;
deriving the first MAC key based on the information for deriving the first MAC key and the AS root key; and
decoding a first MAC message from the first wireless node based on the derived first MAC key.

26. The method of claim 25, further comprising:
receiving, from the centralized wireless node, information for deriving a second MAC key for a second cell group associated with a second wireless node, wherein the first wireless node and the second wireless node are associated with a same centralized wireless node;
deriving the second MAC key; and
decoding a second MAC message from the second wireless node based on the derived second MAC key.

27. The method of claim 26, wherein the first cell group is configured as an active cell group, wherein the second cell group is configured as a candidate cell group, and further comprising receiving an indication of the active cell group and the candidate cell group.

28. The method of claim 25, further comprising:
receiving key derivation parameters for a third MAC key of a third cell group, wherein the third cell group is associated with a third wireless node, and wherein third MAC key is based on a different AS root key; and
decoding a second MAC message from the third wireless node based on the third MAC key after handing over to the third wireless node.

29. The method of claim 25, wherein a MAC key is derived based on at least one of:
a string associated with the first cell group,
a physical cell identifier,
an absolute radio frequency channel number for downlink channel binding, or
a freshness parameter.

30. The method of claim 29, further comprising:
receiving an indication to refresh the first MAC key; and
refreshing the first MAC key based on at least one of the first MAC key, or the freshness parameter.
